(19) United States
(12) Patent Application Publication
(10) Pub. No.: US 2017/0080434 A1
(43) Pub. Date: Mar. 23, 2017

(54) Biaxial shearing crusher

(71) Applicant: Bioland Environmental Technologies Group Corp. Ltd. (Beijing Branch), Beijing (CN)

(72) Inventors: Junying Shi, Beijing (CN); Yichao Ping, Beijing (CN); Chao Wang, Beijing (CN)

(73) Assignee: Bioland Environmental Technologies Group Corp. Ltd. (Beijing Branch)

(21) Appl. No.: 15/371,213

(22) Filed: Dec. 7, 2016

(51) Int. Cl. B02C 18/18; B02C 18/08

(52) U.S. Cl. CPC B02C 18/182; B02C 18/08; B02C 2018/164

(57) ABSTRACT

A biaxial shearing crusher includes: two rotating shafts (5) arranged in parallel; cutting discs (3) respectively sleeved on the two rotating shafts (5) in a perpendicular form and rotating with the rotating shafts (5), wherein the cutting discs (3) on one of the rotating shafts (5) radially extend into spaces formed by the adjacent cutting discs (3) on the opposing rotating shaft (5); a tank (2) having a top opening and a bottom opening, wherein the two rotating shafts (5) are arranged in the tank (2); plates (4) mounted on sidewalls (9) of the tank (2), wherein the plates (4) extends into spaces formed by the sidewalls (9) and the adjacent cutting discs (3); a holder (6), wherein the tank (2) is mounted on the holder (6); and motors (1) mounted on the holder (6), wherein the two motors (1) drive the two rotating shafts (5) to rotate oppositely for crushing.

### BACKGROUND OF THE PRESENT INVENTION

1. Field of Invention

The present invention relates to a technical field of waste crushing, and more particularly to a biaxial shearing crusher.

2. Description of Related Arts

Conventionally, the amount of waste produced annually in the global has reached 500 million tons, which requires more land to pile the waste. However, special reserved lands for piling the waste have been more and more difficult to find. During landfill of waste, chemicals may leak, leading to contamination of groundwater and land. In addition, waste incineration may cause air pollution. For the excess waste, the most effective solution is classification and reutilization.

Waste crusher is necessary in waster pre-treatment. In China, early crusher research is focused on the crusher used as mining machinery, mainly for crushing brittle and rigid materials. Such crusher mainly comprises hammer and counter crusher systems, which is not applicable to flexible and tough materials, and is far from satisfying crushing requirements of failed to meet the requirements of municipal solid waste. Furthermore, there are few crushers specifically designed for municipal solid waste.

Therefore, it is necessary to develop a biaxial shearing crusher which is focused on municipal solid waste characteristics such as low hardness and high content of tough materials.

### SUMMARY OF THE PRESENT INVENTION

An object of the present invention is to provide a crusher which solves the above problems.

Accordingly, in order to accomplish the above objects, the present invention provides a biaxial shearing crusher, comprising:

two rotating shafts (5) arranged in parallel, wherein the two rotating shafts (5) rotate oppositely with an interval of D therebetween;

a plurality of cutting discs (3) respectively sleeved on the two rotating shafts (5) in a perpendicular form and rotating with the rotating shafts (5), wherein for each rotating shaft (5), a distance between a farthest point of each of the cutting discs (3) and the rotating shaft (5) is more than D/2 and less than D; a thickness of each of the cutting discs (3) is T, and a distance between adjacent cutting discs (3) is more than T and less than 2T; the cutting discs (3) on one of the rotating shafts (5) radially extend into spaces formed by the adjacent cutting discs (3) on the opposing rotating shaft (5);

a tank (2) having a top opening and a bottom opening, wherein the two rotating shafts (5) are arranged in the tank (2); materials to be crushed are inputted from the top opening, and then outputted from the bottom opening after being crushed and dragged down by the cutting discs (3) on the two rotating shafts (5);

a plurality of plates (4) mounted on sidewalls (9) of the tank (2), wherein the plates (4) extends into spaces formed by the sidewalls (9) and the adjacent cutting discs (3), so as to prevent the materials from dropping through the spaces formed by the sidewalls (9) and the adjacent cutting discs (3);

a holder (6), wherein the tank (2) is mounted on the holder (6); and

two motors (1) mounted on the holder (6), wherein the two rotating shafts (5) extend out of the tank (2) and are respectively connected to the two motors (1); the two motors (1) drive the two rotating shafts (5) to rotate oppositely for crushing.

Preferably, the rotating shafts (5) are detachably mounted in the tank (2), and the cutting discs (3) are detachably mounted on the rotating shafts (5) with screw threads; the sidewalls (9) of the tank (2) are detachably mounted with bolts, and are detached before replacing the rotating shafts (5).

Preferably, each of the cutting discs (3) comprises a plurality of tooth units (7) for shearing the materials to be crushed, and a plurality of hook parts (8) for tearing and dragging the materials down while crushing.

Preferably, each of the motors (1) comprises a protecting system which controls the motor (1) to reversely rotate for one circle when a working load is more than a preset load, and then recovers the motor (1) to rotate forwardly.

Preferably, the interval D is 200 cm and the thickness T is 100 cm.

The biaxial shearing crusher according to the present invention is suitable for refinement of materials during solid waste pre-processing, with advantages such as small size, low power consumption, wide adaptability to raw materials, low rotating rate, high efficiency, high crushing rate and low noise. The biaxial shearing crusher cuts large pieces of solid waste to small pieces with a diameter of less than 100 mm. The biaxial shearing crusher is suitable for pre-treatment of various materials such as wood, plastic, tyres, organic waste, waste iron sheet and other municipal solid waste.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a biaxial shearing crusher according to the present invention.

FIG. 2 is a sketch view of a cutting disc of the present invention.

### DETAILED DESCRIPTION OF THE PREFERRED EMBODIMENT

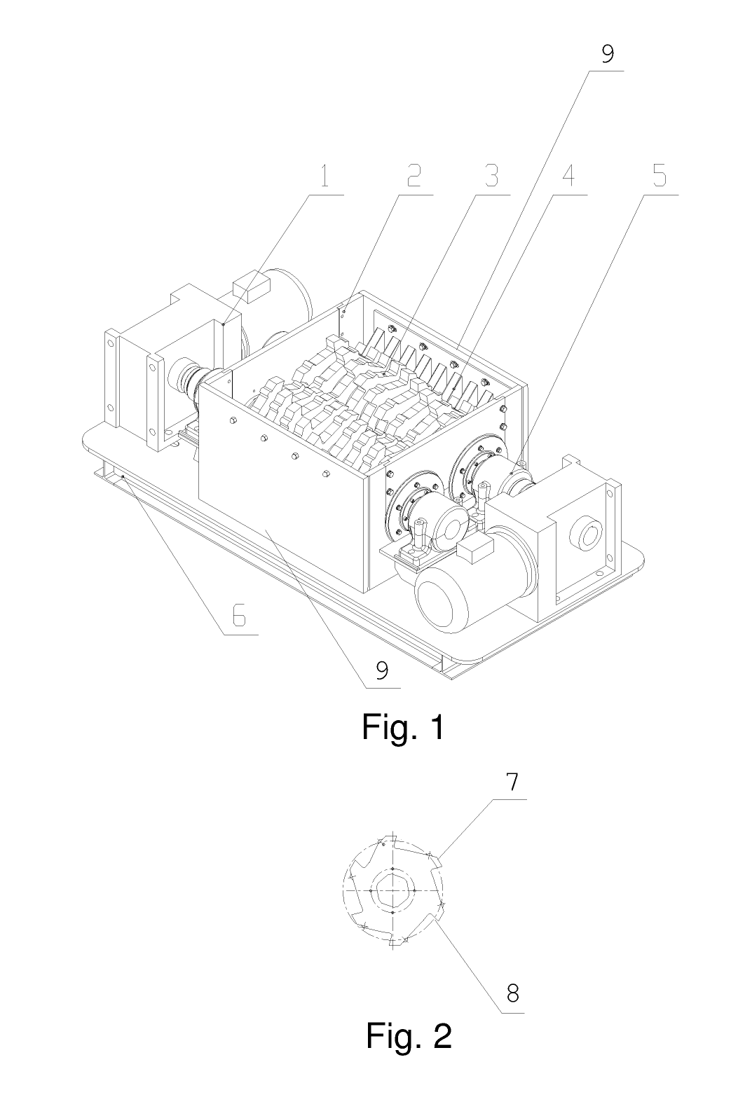

Referring to FIG. 1 of the drawings, a biaxial shearing crusher according to a preferred embodiment of the present invention is illustrated, comprising:

two rotating shafts 5 arranged in parallel, wherein the two rotating shafts 5 rotate oppositely with an interval of D therebetween;

a plurality of cutting discs 3 respectively sleeved on the two rotating shafts 5 in a perpendicular form and rotating with the rotating shafts 5, wherein for each rotating shaft 5, a distance between a farthest point of each of the cutting discs 3 and the rotating shaft 5 is more than D/2 and less than D; a thickness of each of the cutting discs 3 is T, and a distance between adjacent cutting discs 3 is more than T and less than 2T; the cutting discs 3 on one of the rotating shafts 5 radially extend into spaces formed by the adjacent cutting discs 3 on the opposing rotating shaft 5;

a tank 2 having a top opening and a bottom opening, wherein the two rotating shafts 5 are arranged in the tank 2; materials to be crushed are inputted from the top opening, and then outputted from the bottom opening after being crushed and dragged down by the cutting discs 3 on the two rotating shafts 5;

a plurality of plates 4 mounted on sidewalls 9 of the tank 2, wherein the plates 4 extends into spaces formed by the sidewalls 9 and the adjacent cutting discs 3, so as to prevent the materials from dropping through the spaces formed by the sidewalls 9 and the adjacent cutting discs 3;

a holder 6, wherein the tank 2 is mounted on the holder 6; and

two motors 1 mounted on the holder 6, wherein the two rotating shafts 5 extend out of the tank 2 and are respectively connected to the two motors 1; the two motors 1 drive the two rotating shafts 5 to rotate oppositely for crushing.

Preferably, the rotating shafts 5 are detachably mounted in the tank 2, and the cutting discs 3 are detachably mounted on the rotating shafts 5 with screw threads; the sidewalls 9 of the tank 2 are detachably mounted with bolts, and are detached before replacing the rotating shafts 5.

Preferably, each of the cutting discs 3 comprises a plurality of tooth units 7 for shearing the materials to be crushed, and a plurality of hook parts 8 for tearing and dragging the materials down while crushing.

Preferably, each of the motors 1 comprises a protecting system which controls the motor 1 to reversely rotate for one circle when a working load is more than a preset load, and then recovers the motor 1 to rotate forwardly.

Preferably, the interval D is 200 cm and the thickness T is 100 cm.

With the forgoing structure, the cutting discs 3 on the rotating shafts 5 cooperate with each other for shearing. Conventional double-roll crusher has a similar structure as that of the present invention, but crushes by squeezing instead of shearing, which is not able to crushing tough materials. According to the present invention, the hook parts 8 of the cutting discs 3 tear and drag the materials down, while cuts and shears the materials by cooperating with the cutting discs 3 on the opposing rotating shaft 5 like scissors. Therefore, the biaxial shearing crusher is suitable for crushing various materials such as wood, plastic, tyres, organic waste, waste iron sheet and other municipal solid waste. Crushed materials are discharged from a bottom of the biaxial shearing crusher.

The biaxial shearing crusher according to the present invention is suitable for refinement of materials during solid waste pre-processing, with advantages such as small size, low power consumption, wide adaptability to raw materials, low rotating rate, high efficiency, high crushing rate and low noise. The biaxial shearing crusher cuts large pieces of solid waste to small pieces with a diameter of less than 100 mm. The biaxial shearing crusher is suitable for pre-treatment of various materials such as wood, plastic, tyres, organic waste, waste iron sheet and other municipal solid waste.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A biaxial shearing crusher, comprising:
two rotating shafts (5) arranged in parallel, wherein the two rotating shafts (5) rotate oppositely with an interval of D therebetween;
a plurality of cutting discs (3) respectively sleeved on the two rotating shafts (5) in a perpendicular form and rotating with the rotating shafts (5), wherein for each rotating shaft (5), a distance between a farthest point of each of the cutting discs (3) and the rotating shaft (5) is more than D/2 and less than D; a thickness of each of the cutting discs (3) is T, and a distance between adjacent cutting discs (3) is more than T and less than 2T; the cutting discs (3) on one of the rotating shafts (5) radially extend into spaces formed by the adjacent cutting discs (3) on the opposing rotating shaft (5);
a tank (2) having a top opening and a bottom opening, wherein the two rotating shafts (5) are arranged in the tank (2); materials to be crushed are inputted from the top opening, and then outputted from the bottom opening after being crushed and dragged down by the cutting discs (3) on the two rotating shafts (5);
a plurality of plates (4) mounted on sidewalls (9) of the tank (2), wherein the plates (4) extends into spaces formed by the sidewalls (9) and the adjacent cutting discs (3), so as to prevent the materials from dropping through the spaces formed by the sidewalls (9) and the adjacent cutting discs (3);
a holder (6), wherein the tank (2) is mounted on the holder (6); and
two motors (1) mounted on the holder (6), wherein the two rotating shafts (5) extend out of the tank (2) and are respectively connected to the two motors (1); the two motors (1) drive the two rotating shafts (5) to rotate oppositely for crushing.

2. The biaxial shearing crusher, as recited in claim 1, wherein the rotating shafts (5) are detachably mounted in the tank (2), and the cutting discs (3) are detachably mounted on the rotating shafts (5) with screw threads; the sidewalls (9) of the tank (2) are detachably mounted with bolts, and are detached before replacing the rotating shafts (5).

3. The biaxial shearing crusher, as recited in claim 1, wherein each of the cutting discs (3) comprises a plurality of tooth units (7) for shearing the materials to be crushed, and a plurality of hook parts (8) for tearing and dragging the materials down while crushing.

4. The biaxial shearing crusher, as recited in claim 2, wherein each of the cutting discs (3) comprises a plurality of tooth units (7) for shearing the materials to be crushed, and a plurality of hook parts (8) for tearing and dragging the materials down while crushing.

5. The biaxial shearing crusher, as recited in claim 1, wherein each of the motors (1) comprises a protecting system which controls the motor (1) to reversely rotate for one circle when a working load is more than a preset load, and then recovers the motor (1) to rotate forwardly.

6. The biaxial shearing crusher, as recited in claim 2, wherein each of the motors (1) comprises a protecting system which controls the motor (1) to reversely rotate for one circle when a working load is more than a preset load, and then recovers the motor (1) to rotate forwardly.

7. The biaxial shearing crusher, as recited in claim 3, wherein each of the motors (1) comprises a protecting system which controls the motor (1) to reversely rotate for one circle when a working load is more than a preset load, and then recovers the motor (1) to rotate forwardly.

8. The biaxial shearing crusher, as recited in claim 4, wherein each of the motors (1) comprises a protecting system which controls the motor (1) to reversely rotate for one circle when a working load is more than a preset load, and then recovers the motor (1) to rotate forwardly.

9. The biaxial shearing crusher, as recited in claim 1, wherein the interval D is 200 cm and the thickness T is 100 cm.

10. The biaxial shearing crusher, as recited in claim 2, wherein the interval D is 200 cm and the thickness T is 100 cm.

11. The biaxial shearing crusher, as recited in claim 3, wherein the interval D is 200 cm and the thickness T is 100 cm.

12. The biaxial shearing crusher, as recited in claim 4, wherein the interval D is 200 cm and the thickness T is 100 cm.

13. The biaxial shearing crusher, as recited in claim 5, wherein the interval D is 200 cm and the thickness T is 100 cm.

14. The biaxial shearing crusher, as recited in claim 6, wherein the interval D is 200 cm and the thickness T is 100 cm.

15. The biaxial shearing crusher, as recited in claim 7, wherein the interval D is 200 cm and the thickness T is 100 cm.

16. The biaxial shearing crusher, as recited in claim 8, wherein the interval D is 200 cm and the thickness T is 100 cm.
